(19) United States
(12) Patent Application Publication
(10) Pub. No.: US 2025/0068798 A1
(43) Pub. Date: Feb. 27, 2025

(54) METHOD, SYSTEM, MEDIUM, DEVICE AND TERMINAL FOR TRANSIENT ELECTROMAGNETIC PROBING DEPTH PREDICTION

(71) Applicant: University of Electronic Science and Technology of China, Yangtze River Delta Research Institute, Huzhou (CN)

(72) Inventors: Rongjiang Tang, Huzhou (CN); Lu Gan, Huzhou (CN); Fusheng Li, Huzhou (CN); Fengli Shen, Huzhou (CN)

(21) Appl. No.: 18/383,419

(22) Filed: Oct. 24, 2023

(30) Foreign Application Priority Data
Aug. 25, 2023 (CN) 2023110840508

(51) Int. Cl. G06F 30/27

(52) U.S. Cl. CPC G06F 30/27; G06F 2111/10

(57) ABSTRACT

The present disclosure belongs to the field of geophysical exploration, and discloses a method, a system, a medium, a device and a terminal for predicting the probing depth of transient electromagnetic. Based on the existing published resistivity model database, the transient electromagnetic field in layered medium is calculated, and the probing depth is calculated based on Jacobian matrix to establish a training data set. The simulated induced electromotive force is used as the input of the neural network, and the calculated probing depth is used as the output of the network. A rapid mapping between observation data and probing depth is established by using residual neural network.

### CROSS-REFERENCE TO RELATED APPLICATIONS

This application claims priority under 35 U.S.C. § 119(a) to Chinese Patent Application No. 202311084050.8, filed on August 25. 2023, which is hereby incorporated by reference herein in its entirety.

### TECHNICAL FIELD

The present disclosure belongs to the field of geophysical detection, in particular to a method, a system, a medium, a device and a terminal for transient electromagnetic probing depth prediction.

### BACKGROUND

At present, for any geophysical electromagnetic imaging methods, such as ground and aerial transient electromagnetic probing and frequency domain electromagnetic method. probing depth (or skin depth) has always been one of the most concerned parameters for exploration geophysicists. It not only represents the credible region of the inversion model, but also is the evaluation standard of whether the instrument parameters are set properly. Transient Electromagnetics (TEM) is a technical means to detect the internal structure, petrophysical properties and natural environment of the earth by using an electromagnetic induction method. When it works, it introduces step current and transmits pulsed electromagnetic field. In the process of underground diffusion, a pulsed electromagnetic field will excite induced current in the electrically inhomogeneous body, also known as eddy current; by observing the primary diffusion field and the secondary electromagnetic field generated by the eddy current inside the anomalous body, the underground electrical structure can be inversion obtained. Different from seismic exploration or ground penetrating radar method based on wave equation, in transient electromagnetic method, the propagation of low-frequency electromagnetic field in underground medium satisfies diffusion equation, so it is difficult to obtain its probing depth directly from observation data.

In order to obtain the probing depth of electromagnetic methods (including time domain and frequency domain electromagnetic methods), there are two mainstream methods at present. One is to assume the plane electromagnetic wave incidence under the condition of uniform half space, so as to obtain the approximate relationship between the latest cut-off time (or maximum frequency) and the probing depth. However, this method does not fully consider the uneven resistivity structure and the impact of the number of sampling points, which has great uncertainty. Another method is to calculate the probing depth based on Jacobian matrix of the inversion model. This method can be applied to the calculation of the probing depth of any model, and the influence of noise and sampling points is considered at the same time. However, in the second scheme, a reasonable inversion model must be given first, and the acquisition of the inversion model itself depends on the setting of the probing depth, and the inversion always has multiple solutions and is affected by many parameters, so the probing depth obtained by this method always has certain errors.

Based on the above analysis, the problems and defects of the prior art are as follows:
(1) The first method does not fully consider the influence of uneven resistivity structure and the number of sampling points, and has great uncertainty;
(2) In the second method, a reasonable inversion model needs to be given first, and the acquisition of inversion model itself depends on the setting of probing depth, and inversion always has multiple solutions and is easily affected by various parameters, so the obtained probing depth always has certain errors. Up to now, there is no algorithm to calculate the probing depth directly and precisely by using observation data.

### SUMMARY

Aiming at the problems existing in the prior art. the present disclosure provides a method, a system, a medium, a device and a terminal for transient electromagnetic probing depth prediction.

The disclosure relates to a transient electromagnetic probing depth prediction method. The transient electromagnetic probing depth prediction method comprises:

According to a large number of existing one-dimensional underground resistivity models, the numerical simulation of transient electromagnetic field in layered media is carried out, and the training data set is established. The simulated surface vertical induced electromotive force is taken as the input of neural network, and the calculated probing depth is taken as the output of neural network; a rapid mapping between observation data and probing depth is established by using residual neural network.

Further, the transient electromagnetic probing depth prediction method adopts 100,000 one-dimensional resistivity models conforming to underground structures obtained from the published resistivity model database (Asif et al., 2022), and obtains the probing depth of each model by calculating the sensitivity matrix through the analytical solution of the one-dimensional layered electromagnetic field, which is used as a label of the training data set.

Further, the calculation of probing depth is generally obtained by the following steps (Christiansen and Auken, 2012): (1) one-dimensional inversion of data; (2) interpolating the model obtained by one-dimensional inversion to obtain a multi-layer model with smaller layer thickness; (3) calculating the Jacobian matrix of the interpolated model; (4) obtaining probing depth according to the Jacobian matrix.

Further, the residual neural network of the transient electromagnetic probing depth prediction method establishes a nonlinear mapping between the TEM signal and the probing depth, and the input of the residual neural network consists of two paths, namely, the cut-off time and the induced electromotive force, and the logarithm of the input is taken to reduce the order of magnitude difference of the input data, and the last elements of the two paths are the height of the transmitting coil and the height of the receiving coil, and finally a data volume of 32×1×2 is formed.

Further, 62 elements of two channels are cut-off time and electromotive force data, and 2 elements are elevation data; the number of sampling points is variable, and the number is evenly distributed between 20 and 31, 0 is taken when 31 points are not satisfied.

Further, the earliest and latest cut-off times of the transient electromagnetic probing depth prediction method are also variable, and they respectively obey logarithmic uniform distribution: log10(t_early) ϵ [−5, −4], log10(t_late) ϵ [−3.5, −1.5]. and other time points obey logarithmic distribution between the earliest and latest times, which is suitable for most measured data.

Furthermore, the output of the residual neural network is a Gaussian distribution of the probing depth of 100×1, and the maximum probing depth is 350 m, which depends on the model scale of the training set, and the maximum value of the Gaussian distribution corresponds to the predicted depth.

Further, the residual neural network of the transient electromagnetic probing depth prediction method comprises 8 layers, including 7 convolution layers and 1 pooling layer; step size and filter kernel size are selected according to the optimal super-parameters after many tests, and the constructed model is trained, and finally the probing depth prediction model of TEM can be established.

Another object of the present disclosure is to provide a computer device including a memory and a processor, the memory storing a computer program that, when executed by the processor, causes the processor to perform the transient electromagnetic probing depth prediction method.

Another object of the present disclosure is to provide a computer-readable storage medium storing a computer program that, when executed by a processor, causes the processor to perform the transient electromagnetic probing depth prediction method.

Another object of the present disclosure is to provide an information data processing terminal for realizing the transient electromagnetic probing depth prediction method.

Another object of the present disclosure is to provide a transient electromagnetic probing depth prediction system based on the transient electromagnetic probing depth prediction method, which comprises:

The neural network construction and training module is used to establish a training data set, which takes the simulated transient electromagnetic field as the input of neural network and the calculated probing depth as the output of neural network; residual neural network is used to establish a rapid mapping between the observation data and the probing depth;

The neural network model prediction module is used for designing a model and testing it as well as carrying out numerical simulation on the designed two-dimensional or three-dimensional model to obtain the simulated induced electromotive force observed on the surface, which takes the simulation result as the input of the network to obtain the probing depth.

Combined with the technical scheme and the technical problem solved, the technical scheme claimed by the present disclosure has the advantages and positive effects as follows:

Firstly, the present disclosure takes the cut-off time and the induced electromotive force as inputs and the probability distribution of the probing depth as outputs, and establishes a direct prediction model from observation data to the probing depth, thus avoiding inversion calculation and obtaining the sensitivity matrix, reducing the influence of artificially setting inversion parameters and improving the calculation efficiency. In addition. this method can be used for airborne and ground transient electromagnetic, and can be extended to other electromagnetic probing methods by modifying the network. It has the same calculation accuracy as conventional methods, and can give the uncertainty of probing depth, which is beneficial to the comprehensive interpretation of geological and geophysical data.

The present disclosure firstly provides a prediction method of TEM probing depth based on deep learning. The method takes the cut-off time and the induced electromotive force as inputs and the probabilistic distribution of probing depth as outputs to establish a direct prediction model from the observation data to the probing depth. This method has the same calculation accuracy as the conventional method, improves the calculation efficiency of probing depth, and has strong migration ability and practicability.

Secondly, this method is of great significance in TEM inversion based on neural network. By using this method to predict the probing depth of measured data before inversion, the inversion model can be further constrained, and the non-uniqueness in TEM inversion based on neural network can be reduced and more reliable inversion results can be obtained.

Thirdly, as the inventive auxiliary evidence of the claims of the present disclosure, it is also embodied in the following important aspects:

(1) The expected income and commercial value after the technical scheme of the present disclosure is transformed are as follows:

Through the application of the rapid prediction model of TEM probing depth, the probing depth of the target area can be given rapidly, which provides an important basis for the setting of inversion parameters and instrument parameters, exploration mode, etc. It can reduce the delay and rework of TEM data acquisition, improve the efficiency and quality of inversion imaging, and thus reduce the detection cost.

(2) The technical scheme of the present disclosure fills the technical blank in the industry at home and abroad:

For the inversion method of airborne transient electromagnetic (ATEM) based on deep learning, the ATEM data have different probing depths due to the influence of different parameters and underground structures. For areas below the probing depth, the observation data are no longer sensitive to underground structures, which will inevitably lead to no correlation between the input neurons (observation data) and some output neurons (prediction model) of the neural network, and ultimately reduce the prediction ability of the neural network. However, the traditional calculation of probing depth of ATEM does not fully consider the uneven resistivity structure and the influence of sampling points, which is uncertain. or depends on the inversion model, so it is impossible to estimate the probing depth directly from the observation data. In view of the above problems, the residual neural network proposed by the present disclosure is used to predict the probing depth of ATEM, and the rapid mapping between observation data and probing depth is established through public data set and numerical simulation. It is used to constrain the training data set of deep learning model to ensure the correlation between the input data and the output data, thus improving the prediction ability of the model.

Fourthly, the technical realization is elaborated in detail in each claim. The following are the remarkable technological progress brought by each claim:

1. The present disclosure proposes a method based on neural network to predict the probing depth of TEM. It is a major innovation to realize the direct calculation of probing depth from observation data for the first time.

2. The present disclosure refers to obtaining a large amount of data from the published resistivity model database, which ensures the richness and diversity of the training data set, which is helpful to improve the generalization ability and accuracy of the model.

3. The present disclosure describes in detail how to obtain a training label through a plurality of steps, thereby ensuring the accuracy of the label and improving the prediction effect of the model.

4. The present disclosure uses a residual neural network to establish a nonlinear mapping between the TEM signal and the probing depth. In addition, by taking logarithm of the input data, the order of magnitude difference of the input data is effectively reduced, thus making the model more stable.

5. The present disclosure provides a description of logarithmic uniform distribution for the variability of cut-off time, so that the method can be adapted to different measured data, and the applicability and generalization ability of the method are enhanced.

6. The present disclosure describes in detail the network structure, including the number of layers, the size of the filter core, the step size, etc., and emphasizes the selection of the optimal hyper-parameter through multiple tests. This ensures the effectiveness and robustness of the model.

### BRIEF DESCRIPTION OF THE DRAWINGS

FIG. 1 is a flowchart of a transient electromagnetic probing depth prediction method provided by the embodiment of the present disclosure;

FIG. 2 is a schematic diagram of a transient electromagnetic probing depth prediction method provided by the embodiment of the present disclosure;

FIG. 3 is a schematic diagram of a residual neural network model for realizing probing depth prediction provided by the embodiment of the present disclosure;

FIG. 4 is a schematic diagram of the prediction result of the test set data provided by the embodiment of the present disclosure;

FIG. 5 is a schematic diagram for testing the model provided by the embodiment of the present disclosure;

FIG. 6 is the prediction result of the probing depth of the measured data provided by the embodiment of the present disclosure. The upper figure shows the position of the measured data, the solid line shows the measuring line, and the lower figure shows the inversion result and the prediction result of the probing depth.

### DETAILED DESCRIPTION

In order to make the object, technical scheme and advantages of the present disclosure clearer, the present disclosure is described in further detail below in connection with the embodiments. It should be understood that the specific embodiments described herein are intended to explain the present disclosure only and are not intended to be a limit of the present disclosure.

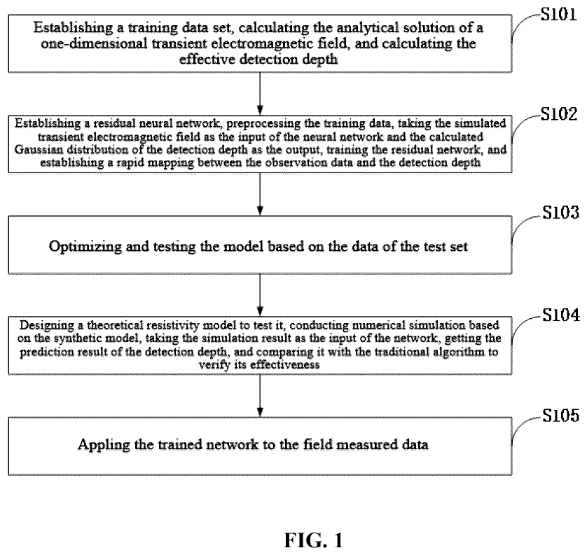

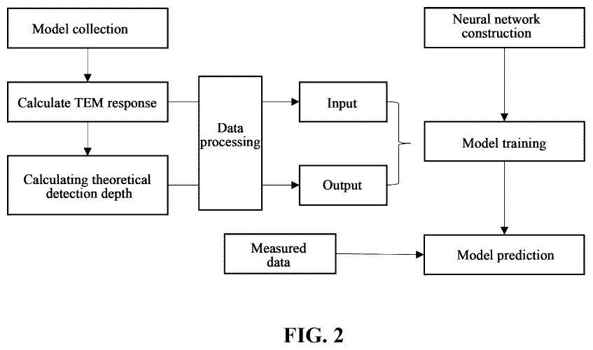

As shown in FIG. 1 and FIG. 2, the transient electromagnetic probing depth prediction method provided by the embodiment of the present disclosure comprises the following steps:
S101: Establishing a training data set, calculating the analytical solution of a one-dimensional transient electromagnetic field, and calculating the probing depth;
S102: Establishing a residual neural network, preprocessing the training data, taking the simulated transient electromagnetic field as the input of the neural network and the calculated Gaussian distribution of the probing depth as the output, training the residual network, and establishing a rapid mapping between the observation data and the probing depth;
S103: Optimizing and testing the model based on the data of the test set;
S104: Designing a theoretical resistivity model to test it. conducting numerical simulation based on the synthetic model, taking the simulation result as the input of the network, getting the prediction result of the probing depth, and comparing it with the traditional algorithm to verify its effectiveness;
S105: Appling the trained network to the field measured data.

The present disclosure provides a description of five main steps of a transient electromagnetic (TEM) probing depth prediction method based on a neural network. For better understanding and implementing, the following is the particular implementation scheme of each step:
S101: Establishing a training data set, calculating the analytical solution of a one-dimensional transient electromagnetic field, and calculating the probing depth;
1.1 Extracting a large number of one-dimensional underground resistivity models from published resistivity model databases or experimental data.
1.2 Applying the analytical solution formula of transient electromagnetic field to these models, the corresponding transient electromagnetic field responses are obtained.
1.3 Calculating the probing depth of each model using Jacobian matrix or other appropriate methods.
S102: Establishing a residual neural network and train it;
2.1 Designing and initializing a residual neural network structure.
2.2 Using appropriate preprocessing techniques (such as normalization, denoising, etc.) to process the simulated transient electromagnetic field data.
2.3 Taking the processed data as the input of neural network; the Gaussian distribution of the calculated probing depth is used as the output label.
2.4 Choosing appropriate loss function, optimizer and learning rate, and train the network.
S103: Optimizing and testing the model based on the data of the test set;
3.1 Separating a part of the original data set as a test set.
3.2 Running the model with test set data and calculate the prediction results.
3.3 Evaluating the performance of the model, such as calculating mean square error and absolute error.
3.4 Adjusting the network parameters or optimize the structure according to the test results.
S104: Designing theoretical resistivity model for testing;
4.1 Designing or selecting multiple theoretical resistivity models.
4.2 Conducting numerical simulation of transient electromagnetic field of these models, and the simulation results are obtained.
4.3 Inputting the simulation results into the neural network, and get the prediction results of probing depth.
4.4 Using traditional algorithms or known methods to calculate the probing depth, and comparing it with the prediction of neural network.
S105: Appling the trained network to the field data;
5.1 Obtaining field transient electromagnetic data.
5.2 Preprocessing the data properly, such as denoising and normalization.
5.3 Inputting the preprocessed data into the trained neural network to get the prediction of probing depth.
5.4 Verify the accuracy and reliability of the predictions according to the field geological information or other reference materials.

The implementation scheme of each step above provides a detailed and structured implementation flow for the transient electromagnetic probing depth prediction method based on neural network.

### Embodiment 1—Establishment of Residual Neural Network

Firstly, a training data set is established. The present disclosure adopts 100,000 one-dimensional resistivity models conforming to underground structures obtained from the published resistivity model database (Asif et al., 2022), and obtains the probing depth of each model by calculating the sensitivity matrix through the analytical solution of one-dimensional layered electromagnetic field (Christiansen and Auken, 2010). The simulated transient electromagnetic field is used as the input of the neural network, and the calculated probing depth is used as the output of the neural network. Then, using 90,000 data as the training set and 10,000 data as the test set, a rapid mapping between observation data and probing depth is established by using residual neural network, and the probing depth is predicted.

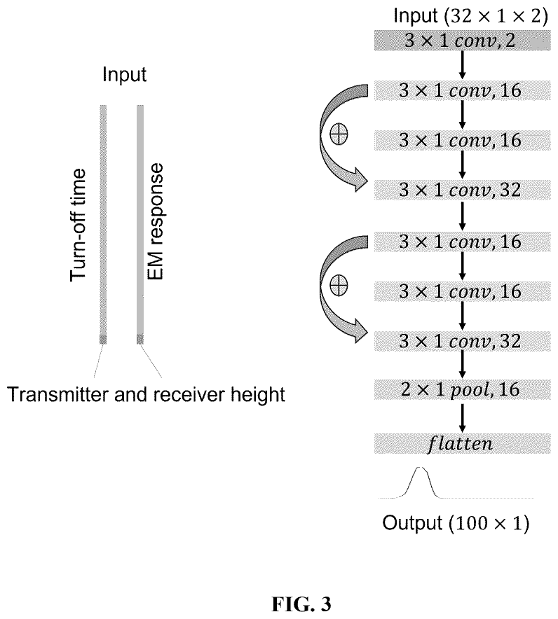

The present disclosure utilizes a residual neural network as shown in FIG. 3 to establish a nonlinear mapping between a TEM signal and the probing depth. The input of residual neural network is composed of cut-off time and induced electromotive force. The logarithm of the input is taken to reduce the order of magnitude difference of the input data. The last element of the two channels is the height of transmitting coil and the height of receiving coil, and the unit is 10 m. Finally, it constitutes a data volume of 32×1×2, in which 62 elements of two channels are cut-off time and electromotive force data, and 2 elements are elevation data; the number of sampling points is variable, and the number is evenly distributed between 20 and 31; the earliest and latest cut-off times are also variable, and they obey logarithmic uniform distribution: log10(t_early) ϵ [−5, −4], log10(t_late) ϵ [−3.5, −1.5], respectively. The rest time points obey logarithmic distribution between the earliest and latest time, which can be applied to most measured data. The output of the residual neural network is a Gaussian distribution of the probing depth of 100×1, and the maximum probing depth is 350 m, which depends on the model scale of the training set, and the maximum value of the Gaussian distribution corresponds to the predicted depth. The network consists of 8 layers, including 7 convolution layers and 1 pooling layer. Step size and filter kernel size are selected according to the optimal hyper-parameters after many tests. Finally, the constructed model is trained.

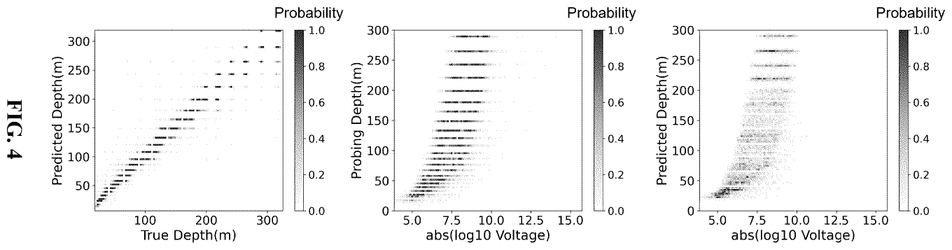

FIG. 4 shows the predictions of the test set of the trained network. It can be seen that most of the points with high probability in the figure are concentrated on the diagonal, and the dispersion degree gradually increases with the change of probing depth from shallow to deep, which shows that the prediction results are in good agreement with the real model on the whole, and the reliability of the predictions is higher when the probing depth is shallow. FIGS. 4b and 4c respectively show the probability distributions of late induced electromotive force and tag depth in the test set, and the probability distributions of late induced electromotive force and predicted depth, which are obviously similar, indicating that the deep learning model can effectively learn the mapping relationship between induced electromotive force and probing depth.

### Embodiment 2—Two-Dimensional Theoretical Model Prediction

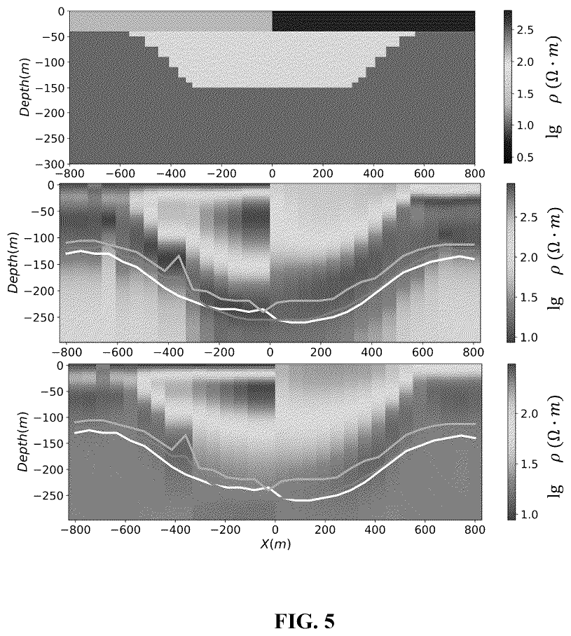

The performance of the algorithm proposed by the present disclosure is tested by designing a model as shown in FIG. 5a. In this model, the surface is composed of half of sub-low resistivity body and half of high resistivity body, and there is a sub-high resistivity body in the middle of the model extending to the deep, and the rest is composed of low resistivity body; by using the two-dimensional numerical simulation of the model and taking the simulation results as the input of the network, the probing depth can be obtained. FIG. 5(b) is the inversion result of an initial model for a homogeneous half-space with a resistivity of 100 Ω·m. FIG. 5(c) is the inversion result of the homogeneous half-space initial model with resistivity of 20 Ω·m. The light gray curve denotes the probing depth predicted by neural network, while the dark and white curves correspond to the probing depth obtained by traditional algorithm based on the inversion models of two initial models, 100 Ω·m and 200 Ω·m.

Due to the weak constraint of observation data on the underground area below the probing depth, the resistivity of the deeper area in the inversion model may be different according to different initial models. Therefore, although there is a slight difference between residual neural network and traditional algorithm in predicting probing depth, this error range is acceptable. In addition, the existence of sub-high resistivity body leads to the increase of probing depth in the middle section, while the probing depth at both ends shows asymmetry due to the difference of surface resistivity. These results show the effectiveness of residual neural network prediction.

### Embodiment 3—Application of Field Measured Data

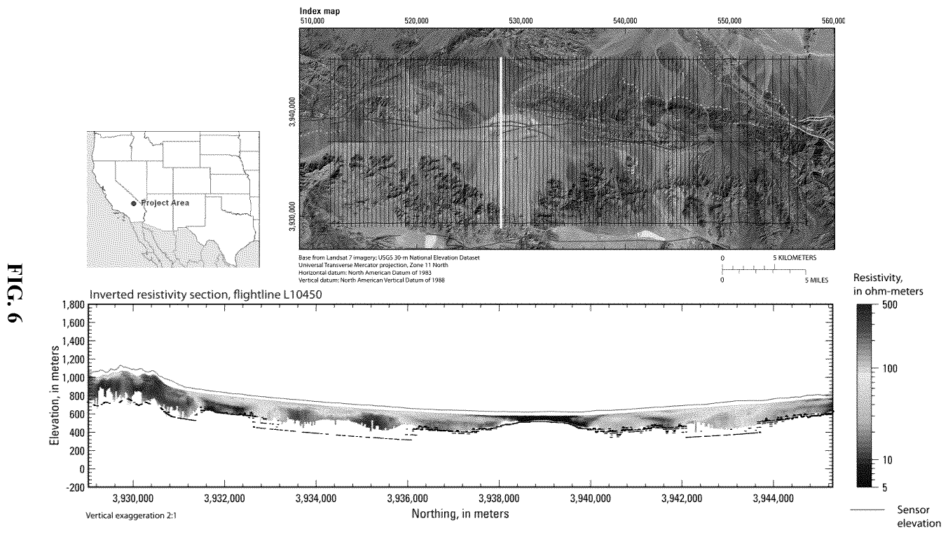

The application ability of the algorithm proposed by the present disclosure in field data is tested by selecting the airborne transient electromagnetic data (FIG. 6) collected by USGS in Leach Lake Basin, California, USA. The inversion profile below has different probing depths, which are obtained by calculating Jacobian matrix from the inverted model (Bedrosian et al., 2014); the black point below the model is the probing depth predicted by the residual neural network used in this disclosure.

It can be seen that the variation trend of probing depth predicted by residual neural network is basically consistent with that calculated by Jacobian matrix of inversion model, that is, the probing depth is shallow in the area with lower overall resistivity, larger in the area with higher overall resistivity, and the coincidence degree between them is higher in the area with lower overall resistivity. This shows that the method provided by the present disclosure has strong applicability in field data.

It should be noted that embodiments of the present disclosure may be implemented by hardware or software or a combination of software and hardware. The hardware part can be realized by special logic. The software portion may be stored in memory and executed by a suitable instruction execution system such as a microprocessor or specially designed hardware. Those skilled in the art can understand that the above-mentioned devices and methods can be implemented using computer-executable instructions and/or contained in processor control code, for example, such code is provided on a carrier medium such as a magnetic disk, a CD or DVD-ROM, a programmable memory such as a read-only memory (firmware) or a data carrier such as an optical or electronic signal carrier. The device and its modules of the present disclosure can be realized by hardware circuits such as very large scale integrated circuits or gate arrays, semiconductors such as logic chips and transistors, or programmable hardware devices such as field programmable gate arrays and programmable logic devices, or by software executed by various types of processors, or by a combination of the above hardware circuits and software such as firmware.

The above is only the particular implementation of the present disclosure, but the protection scope of the present disclosure is not limited to this. Any modification, equivalent substitution and improvement made by any person familiar with the technical field within the technical scope disclosed by the present disclosure within the spirit and principle of the present disclosure should be included in the protection scope of the present disclosure.

What is claimed is:

1. A method for transient electromagnetic probing depth prediction, wherein, the method comprising:
performing numerical simulation of a transient electromagnetic field in layered media according to a large number of existing one-dimensional underground resistivity models, calculating an probing depth according to Jacobian matrix, and establishing a training data set;
taking the simulated transient electromagnetic field as an input to a neural network and the calculated probing depth as an output of the network;
establishing a rapid mapping between observation data and probing depth by using residual neural network.

2. The method for transient electromagnetic probing depth prediction according to claim 1, wherein the method further comprising: obtaining 100,000 one-dimensional resistivity models conforming to the underground structure from a published resistivity model database, calculating a sensitivity matrix through an analytical solution of the one-dimensional layered electromagnetic field to obtain the probing depth of each model, and expressing the probing depth by using a Gaussian distribution as a label of the training data set.

3. The method for transient electromagnetic probing depth prediction according to claim 1, wherein the probing depth calculated as a training tag is obtained by the following steps:
(1) performing one-dimensional inversion on the data;
(2) the model obtained by one-dimensional inversion is interpolated to obtain a multilayer model with smaller layer thickness;
(3) calculating the Jacobian matrix of the interpolated model according to a formula;
(4) obtaining the probing depth according to Jacobian matrix.

4. The method for transient electromagnetic probing depth prediction according to claim 1, wherein the method further comprising: establishing a nonlinear mapping between the TEM signal and the probing depth, the input of the residual neural network is composed of two channels of cut-off time and induced electromotive force, the logarithm of the input is taken to reduce the order of magnitude difference of the input data, and the last element of the two channels is the height of the transmitting coil and the height of the receiving coil, and finally a data volume of 32×1×2 is formed;
wherein 62 elements of the two channels are cut-off time and electromotive force data, and 2 elements are elevation data; the number of sampling points is variable, and the number is evenly distributed between 20 and 31.

5. The method for transient electromagnetic probing depth prediction according to claim 1, wherein the earliest and latest cut-off times of the method are also variable, respectively obeying logarithmic uniform distribution: log10(t_early) ϵ [−5, −4], log10(t_late) ϵ [−3.5, −1.5], the other time points follow a logarithmic distribution between the earliest and latest time, which is suitable for different measured data.

6. The method for transient electromagnetic probing depth prediction according to claim 4, wherein the residual neural network comprises a total of 8 layers, including 7 convolution layers and 1 pooling layer; the step size and filter kernel size can be tested for a plurality of times to select the optimal hyper-parameters, and the constructed model can be trained, and finally the probing depth prediction model of TEM can be established.

7. A computer device, comprising a memory and a processor, wherein the memory stores a computer program that, when executed by the processor, causes the processor to perform the method for transient electromagnetic probing depth prediction according to claim 1.

8. A computer-readable storage medium storing a computer program, the computer program being executed by the processor to cause the processor to perform the method for transient electromagnetic probing depth prediction according to claim 1.

9. An information data processing terminal, wherein the information data processing terminal is configured to implement the method for transient electromagnetic probing depth prediction according to claim 1.

10. A system for transient electromagnetic probing depth prediction based on the method for transient electromagnetic probing depth prediction according to claim 1, wherein the system comprises:
a neural network construction and a training module, configured to establish a training data set, take the simulated transient electromagnetic field as an input of the neural network, and take the calculated probing depth as an output of the neural network; the residual neural network is used to establish a rapid mapping between the observation data and the probing depth;
a neural network prediction module used for testing synthetic data or measured data, wherein firstly, the data structure consistent with the input layer of neural network is obtained by data preprocessing, and then the probing depth of TEM can be obtained rapidly by using residual neural network as the input of neural network.
